(19) United States
(12) Patent Application Publication
(10) Pub. No.: US 2013/0125099 A1
(43) Pub. Date: May 16, 2013

(54) MODULAR COMPILATION USING PARTIAL COMPILERS

(71) Applicants: Mihai Budiu, Sunnyvale, CA (US); Gordon D. Plotkin, Edinburgh (GB); Joel Galenson, Berkeley, CA (US)

(72) Inventors: Mihai Budiu, Sunnyvale, CA (US); Gordon D. Plotkin, Edinburgh (GB); Joel Galenson, Berkeley, CA (US)

(73) Assignee: Microsoft Corporation, Redmond, WA (US)

(21) Appl. No.: 13/295,107

(22) Filed: Nov. 14, 2011

(51) Int. Cl. G06F 9/45

(52) U.S. Cl. 717/140

(57) ABSTRACT

A modular compiler architecture utilizes partial compiler modules that cooperatively produce object code for operation on a complex execution infrastructure. The partial compilers may invoke the services of other partial compilers, wherein each partial compiler operates as a self-contained “black-box” module. This structure, in turn, may allow the partial compilers of such implementations to be arranged in modular hierarchies for multi-level compilation and specialization of each partial compiler. These various implementations, in turn, produce compiled programs able to correctly run on large computer clusters comprising a mix of computational resources (machines, multiple cores, graphics cards, SQL server engines, etc.). Certain implementations may also be directed to compilers comprising modular partial compilers, and partial compilers may be formed from generalized forms of traditional compilers. Further disclosed is a set of high-level operations that manipulate partial compilers.

### BACKGROUND

In general, a computer software compiler (or “compiler”) transforms source code written in a source programming language into a target computer language often in a binary form known as object code. A common objective for transforming source code to object code is to create an executable program for a specific computer processor. A compiler is likely to perform many different operations such as lexical analysis, preprocessing, parsing, semantic analysis, code generation, and/or code optimization. Program faults caused by incorrect compiler behavior, however, can be very difficult to track down and work around, and thus well-founded compiler implementations may comprise features for ensuring correctness of the compilation.

Distributed computing is a form of computing—generally by operation of application programs—in which many calculations are carried out simultaneously on the premise that large problems can often be divided into smaller problems which can be solved concurrently (“in parallel”) for efficiency. To accomplish this parallelism, distributed computing makes use of multiple autonomous computers (or processors) to solve computational problems by dividing the problem into many sub-problems that are then solved by one or more of the autonomous computers (or nodes) in a cluster of computers. To perform computations on very large problems or datasets, distributed computing clusters (comprising tens, hundreds, or even thousands of autonomous computers) may be utilized.

Many modern computing systems are comprised of multiple separate complex execution subsystems. For example, a computer may be endowed with multiple processor cores, and/or one or several graphics cards, each having many internal execution cores. Computer clusters are composed of multiple computers. Computers may provide execution services over the network, such as offering database queries or web services. Creating programs for such complex environments involves a complex set of interacting tools, and in particular, the cooperation of multiple compilers. Traditionally the cooperation of the various compilers targeting all these environments is done in ad hoc way.

### SUMMARY

A modular compiler architecture uses partial compiler modules that cooperatively produce object code for operation on a complex execution infrastructure. In a modular compiler implementation, the component partial compilers may invoke the services of other partial compilers, wherein each partial compiler operates as a self-contained “black-box” module, sharing no code or state with other partial compilers. This structure, in turn, may allow the partial compilers of such implementations to be arranged in modular hierarchies for multi-level compilation. These various implementations, in turn, then produce compiled programs able to correctly run on complex execution environments, such as large computer clusters comprising a mix of computational resources (machines, multiple cores, graphics cards, SQL server engines, etc.).

Partial compilers could be seen as a generalization of traditional compilers. Traditional compilers may be used as components of modular compilers and in combination with other partial compilers. Modular compiler implementations may comprise a set of high-level operations that manipulate partial compilers. Certain implementations may also feature a software architecture for modular compiler construction to provide a large-scale query-processing system (compiler) implemented as a modular combination of many simple partial compilers.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

To facilitate an understanding of and for the purpose of illustrating the present disclosure and various implementations, exemplary features and implementations are disclosed in, and are better understood when read in conjunction with, the accompanying drawings—it being understood, however, that the present disclosure is not limited to the specific methods, precise arrangements, and instrumentalities disclosed. Similar reference characters denote similar elements throughout the several views. In the drawings:

FIG. 1 is an illustration of an exemplary networked computer environment in which the numerous implementations disclosed herein may be utilized;

FIG. 2A illustrates a self-contained compiler;

FIG. 2B illustrates an exemplary modular compiler representative of several implementations disclosed herein;

FIG. 3A is a process flow diagram illustrating the operation of an exemplary partial compiler representative of several implementations disclosed herein;

FIG. 3B is a process flow diagram illustrating the operation of a self-contained compiler;

FIG. 4A illustrates an exemplary tensor operation that may be utilized by several implementations disclosed herein;

FIG. 4B illustrates an exemplary “star” operation that may be utilized by several implementations disclosed herein;

FIG. 4C illustrates an exemplary “conditional” operation that may be utilized by several implementations disclosed herein;

FIG. 4D illustrates an exemplary “case” operation (as an extension of the conditional operation) that may be utilized by several implementations disclosed herein;

FIG. 4E illustrates an exemplary “iteration” operation that may be utilized by several implementations disclosed herein; and

FIG. 5 shows an exemplary computing environment.

### DETAILED DESCRIPTION

A multicore processor is a processor that includes multiple execution units (“cores”) on the same chip, enabling it to process simultaneously instructions from multiple instruction streams. A multiprocessor computer, in comparison, is a stand-alone computer system (or “machine”) with multiple processors that share memory and may connect via a bus, point-to-point links, or other high-speed means; however, “bus contention” (where more than one processor attempts to use the bus at the same time) and similar limitations often prevent such computing systems from scaling to more than thirty-two (32) processors. As such, a multiprocessor computer may comprise one or more multicore processors for multiplying computational power.

A distributed computer (sometime referred to as a distributed memory multiprocessor) is comprised of multiple processors connected by a network (and thus is highly scalable) to solve computational problems using parallel computing (where a problem is divided into many sub-problems, each of which is solved by different processor). For example, a massively parallel processor (MPP) is a single stand-alone computer with many networked processors using specialized high-speed interconnect networks where generally each processor has its own memory, copy of the operating system, and copy of the application(s). In contrast, a cluster (or cluster computer system) is a distributed computer comprising multiple computer systems (each a “cluster computer,” “autonomous computer,” or a “machine”) connected by a network where each machine has its own processing elements, memory, operating system, and applications, and the network generally comprises commodity networking hardware. A grid computer system (or grid) is similar to a cluster but where the networked computers communicate over the Internet which, because of its relatively low bandwidth and high latency, are the most distributed form of parallel computing and typically deals only with “embarrassingly parallel” problems, that is, problems that are easily split into parallel tasks that require little or no communication between such tasks.

A distributed computer—whether an MPP, a cluster, or a grid—may comprise one or more multiprocessor computers and/or comprise one or more multicore processors. There are also several specialized parallel/distributed computer systems based on reconfigurable computing systems with field-programmable gate arrays, general-purpose computing systems on graphics processing units, application-specific integrated circuits, and vector processors, to name a few, for example.

Notwithstanding the foregoing, the terms “concurrent,” “parallel,” and “distributed” strongly overlap, and are used interchangeably herein such that a same system may be characterized as “parallel” and/or “distributed” without loss of generality such that processors in a distributed system run concurrently in parallel. Where distinctions are necessary and the terms are disjunctively and in obvious conflict to a person of ordinary skill in the relevant art, then the term “parallel” as used in parallel computing shall refer to all processors having access to a shared memory that can be used to exchange information between processors, whereas the term “distributed” as used in distributed computing shall refer to each processor having its own private memory (a part of the “distributed memory”) where information is exchanged by passing messages between the processors (presumably through an intermediary of some kind).

While various implementations disclosed herein are described in terms of a distributed computing system and, more specifically, in terms of a cluster computer system (or “distributed computing cluster”), skilled artisans will readily recognize that such implementations can readily be implemented on other types of distributed computing systems, and nothing is intended to limit the implementations disclosed herein to any specific distributed computer type nor to any specific configuration of processors such as multiprocessors but, instead, are intended to be given the widest interpretations possible.

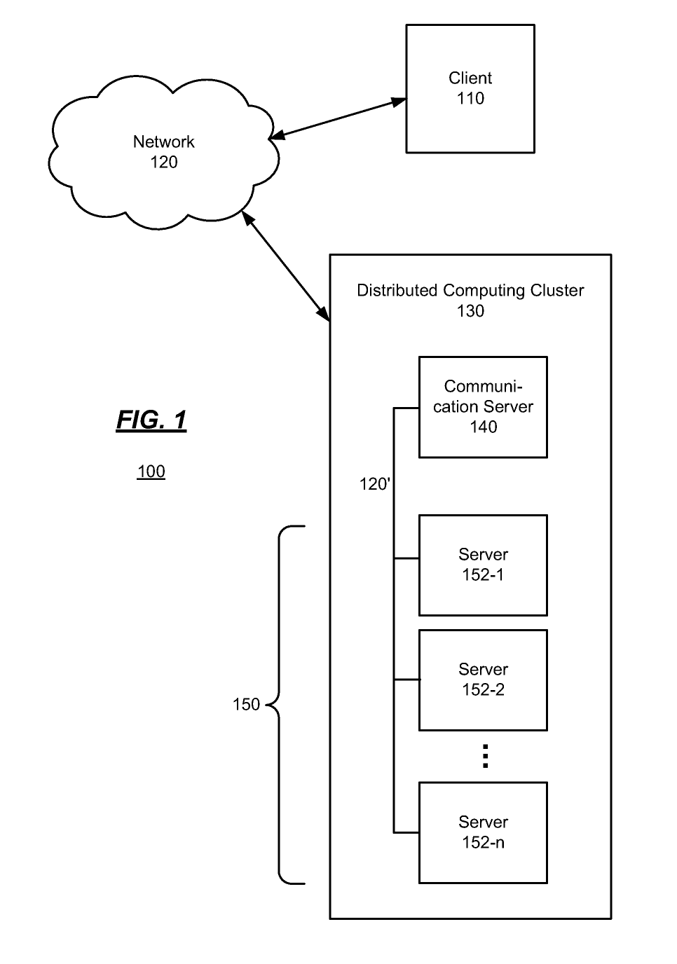

FIG. 1 is an illustration of an exemplary networked computer environment 100 in which the numerous implementations disclosed herein may be utilized. The network environment 100 may include one or more clients, such as a client 110, configured to communicate with each other or with one or more servers, such as a communication server 140, through a network 120. The network 120 may be a variety of network types including the public switched telephone network (PSTN), a cellular telephone network, and a packet switched network (e.g., the Internet). While the client 110 and the server 140 are illustrated as being connected by the network 120, in some implementations it is contemplated that the client 110 and the server 140 may be directly connected to each other or even executed by the same computing system.

As shown in FIG. 1, and for several implementations disclosed herein, the communication server 140 may be part of a distributed computing cluster 130 comprising the communication server 140 and other computers (or processors) in a processing cluster 150 comprising a plurality of cluster machines (or simply “servers”) 152-1, 152-2, . . . , 152-n (each also referred to interchangeably as a “machine”, “cluster server”, “cluster computer,” or “autonomous computer”) interconnected by a network 120′. The communication server 140 may be a separate machine from the machines in the processing cluster 150 (as shown) or the communication server 140 may also comprise a machine in the processing cluster 150. Moreover, the network 120′ may be local network of some kind (e.g., a local area network or LAN) or it may be an extension of a larger network such as network 120.

In some implementations, the client 110 may include a desktop personal computer, workstation, laptop, PDA, cell phone, smart phone, or any WAP-enabled device or any other computing device capable of interfacing directly or indirectly with the network 120, such as a computing device 500 illustrated in FIG. 5. The client 110 may run an HTTP client, e.g., a browsing program, such as MICROSOFT INTERNET EXPLORER or other browser, or a WAP-enabled browser in the case of a cell phone, PDA or other wireless device, or the like, allowing a user of the client 110 to access information available to it at the communication server 140 or to provide information to the communication server 140. Other applications may also be used by the client 110 to access or provide information to the communication server 140, for example. In some implementations, the server 140 may be implemented using one or more general purpose computing systems such as the computing device 500 illustrated in FIG. 5.

For simplicity, although in no way limited to such, various implementations disclosed herein may be characterized in the context of an exemplary distributed computing compiler, specifically, the DryadLINQ compiler and its underlying distributed runtime system Dryad. DryadLlNQ translates programs written in the “Language INtegrated Query” (LINQ) database programming language into large-scale distributed computations that run on shared-nothing computer clusters and, as such, the basic functionality provided by DryadLlNQ includes compiling programs for execution on a computer cluster. In this sense, a cluster may be abstractly viewed as a single computational engine composed of many computers that perform the actual computational work. Moreover, although nothing herein is tied to any particular query language, some of the terminology used herein is similarly inherited from LINQ, which is itself derived from various database applications, and thus inputs for partial compilers are referred to as “queries” while outputs generated by partial compilers are referred to as “plans.”

At a lower level of abstraction, however, it should be noted that each such computer in the cluster may itself also have multiple processor cores (multiprocessors or multicores). Consequently, the DryadLlNQ compilation process is correspondingly structured as a three-stage process: (1) translating a cluster-level computation (or program) into a set of interacting machine-level computations, (2) translating each machine-level computation into a set of processor-core-level computations, and (3) implementing each processor-core-level computation as machine-executable code. For DryadLlNQ, the LINQ source-code language is essentially the same for all of these layers; however, the optimization strategies, program transformation rules, and runtime operations invoked by the compiler at each of these levels—cluster, machine, and core—may be very different, and thus decomposing the DryadLlNQ compiler into a hierarchy of compilers (corresponding to each level) that cooperate to implement a single computation is embodied by various implementations disclosed herein.

Of course, there is no language useful for all purposes and thus there is a need for multiple types of queries and plans. In some circumstances, the queries and plans may be written in the same language, or in different languages. Moreover, partial compilers can be used to handle mixed languages by translating between the various query and plan types.

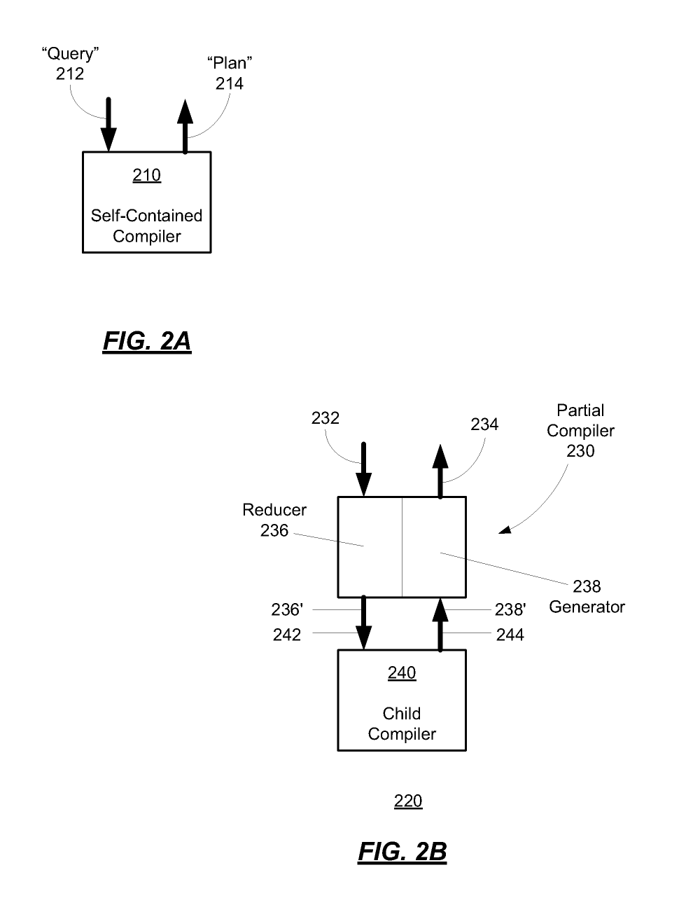

FIG. 2A illustrates a self-contained compiler 210, and FIG. 2B illustrates an exemplary modular compiler 220 representative of several implementations disclosed herein. In FIG. 2A, the self-contained compiler 210—which, as used herein, is any compiler other than a partial compiler—receives a source program or queries 212 as inputs and transforms them into plans 214 as outputs. The queries 212 received as input may comprise, for example, source code from a higher-order programming language, and the target program or plans 214 produced as output may comprise, for example, object code in binary form for direct execution by one or more processor cores. In FIG. 2B, however, the exemplary modular compiler 220 may comprise one or more partial compilers 230 operatively coupled to one or more child compilers 240. Both the partial compilers 230 and the child compilers 240 receive queries 232 and 242, respectively, as inputs and transform them into plans 234 and 244, respectively, as outputs.

As illustrated, the partial compiler, in turn, further comprises a reducer 236 and a generator 238 wherein (a) the reducer 236 reduces its received queries to produce one or more sub-queries 236′ which are then passed (via the operative coupling) to one or more child compilers 240 as input queries 242 for such child compilers 240 and (b) the generator 238 receives (via the operative coupling) one or more sub-plans 238′ from the one or more child compilers 240 as output plans 244 from such child compilers 240 (in response to the sub-query 236′) from which the generator 238 generates and outputs it collective plan 234. As such, the reducer 236 and the generator 238 are separate but interdependent pieces that perform, respectively, query reduction and plan generation. The generator also can use query 232 when constructing the collective plan 234.

It should be noted that, in certain implementations, a child compiler may itself comprise one or more partial compilers and one or more child compilers. Moreover, in these and other such implementations, a child compiler may instead comprise one or more self-contained compilers 210. Thus, hierarchical modular constructions of partial compilers 230 and child compilers 240—wherein each child compiler 240 in turn comprises either partial compilers 230 or self-contained compilers 210—are readily possible in the form of tree structures of varying breadths and depths. Moreover, for some implementations, it may be said that for an n-ary partial compiler there is a need for n child compilers such that, given an input query, the partial compiler returns n sub-queries by “reducing” the original query to a set of n “simpler” (or sub-component) sub-queries; and the partial compiler also returns a plan that, given sub-plans resulting from these n queries, it then uses to generate an output plan for the original query. In addition, each compiler—partial or self-contained—may be presented as a “black-box” component with well-defined inputs, outputs, and functionality but without exposing the internal operation of such components. Lastly, a partial compiler may either partially compile a received query into a plan in addition to utilizing the sub-plans provided by a child compiler, or the partial compiler may further comprise a feature by which it inspects the received query and elects to operate as either a self-contained compiler or as a partial compiler.

Consequently, certain such implementations comprising a modular compiler operate such that a first partial compiler requires help from a first child compiler, and the first child compiler may itself be a second partial compiler that requires help from a second child compiler, and so on and so forth until the child compiler is a self-contained compiler or, for certain alternative implementations, a partial compiler that can act as either a partial compiler (and engage other compilers) or as a self-contained compiler (when no help is necessary). In any event, various implementations disclosed herein anticipate that the partial compiler may complete part of the compilation on the query itself to produce at least portions of the plan without assistance from any child compilers. In any event, the modular approach is intended to ease the complexity of compilation for complex source code such as source code intended for execution on a cluster.

For various such implementations, partial compilers are a generalization of self-contained compilers that, on receipt of a query, enlist the help of child compilers to perform the compilation. For example, the functionality of the DryadLINQ compiler can be provided by using a cluster-level partial compiler to generate a plan to distribute sub-queries among many machines and instruct child compilers for such machines to perform a sub-compilation (a part of the larger whole). To generate a plan for each such child compiler, the cluster-level compiler creates a machine-level sub-query which is then handed as a query to a machine-level child compiler. The machine-level child compiler then generates a machine-level plan which is returned as a sub-plan to the cluster-level partial compiler, and the cluster-level partial compiler uses this sub-plan to generate its own plan. In addition, for certain implementations, the machine-level child compiler may itself be a partial compiler that generates and distribute sub-queries for a plurality of processor cores (e.g., when targeting machines containing multicore processors) and instructs child compilers (which may be self-contained compilers) for each such processor core to perform the sub-compilations.

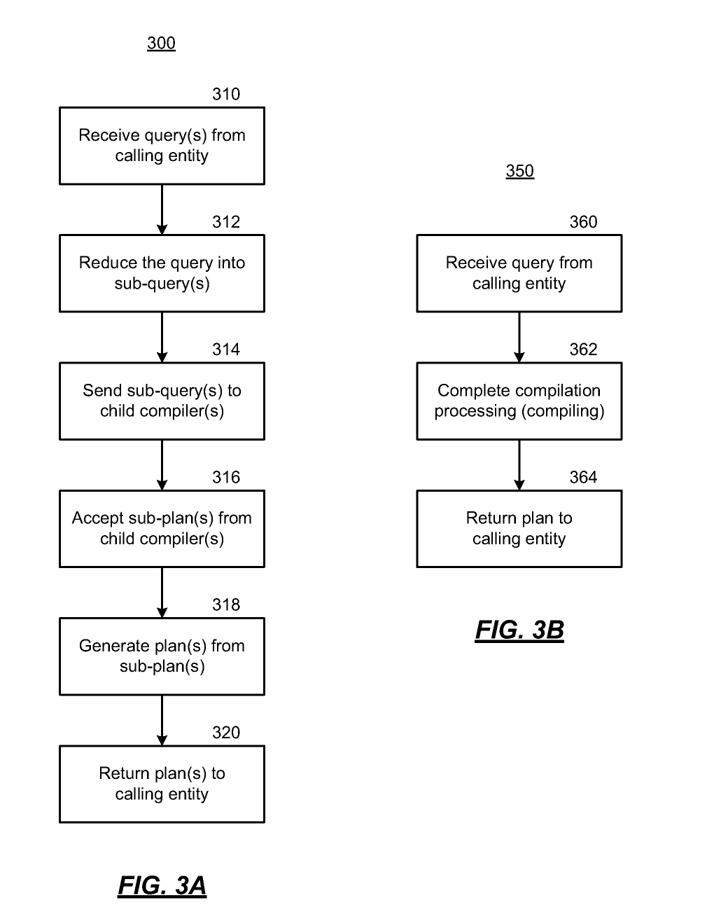

FIG. 3A is a process flow diagram 300 illustrating the operation of an exemplary partial compiler representative of several implementations disclosed herein. At 310, the partial compiler receives a query and, at 312, the partial compiler reduces that query into one or more sub-queries that are passed (or sent), at 314, as input queries to one or more child compilers. At 316, the partial compiler accepts the sub-plan from each child compiler and, at 318, generates a plan from these sub-plans which, at 320, it returns as the output plan to the entity (process, etc.) that originally submitted the query. For each child compiler that is itself a partial compiler, the foregoing process is iteratively repeated. On the other hand, for each child compiler that is itself a self-contained compiler, the process for that compiler may be akin to that described with regard to FIG. 3B.

FIG. 3B is a process flow diagram 350 illustrating the operation of a self-contained compiler. In FIG. 3B, at 360, the self-contained compiler receives a query, completes compilation processing at 362 without calling to another compiler (unlike a partial compiler), and at 364 returns its output plan to the entity that originally submitted the query.

For certain implementations using a hierarchical modular approach, different compilers could be used to operate for generating code for different processors (having different processing capabilities, resources, etc.) as child processes under the control of a partial compiler. For example, compilation might be performed for a machine having two processor cores (CPUa and CPUb) and a graphics card processor (GPU). In these implementations, two different partial compilers might be used: one which generates plans running the GPU, and another which generates plans for the processor cores. If these compilers are organized as child compilers to a machine-level partial compiler, then given a query, the machine-level partial compiler might choose to send parts of the query as sub-queries to the child compilers targeting the processor cores while other parts are sent as sub-queries to the child compiler targeting the GPU.

To build hierarchical modular compilers for various implementations disclosed herein, one basic operation is “composition” by which one or more partial compilers and self-contained compilers are combined together to form the desired compiler functionality. As such, the composition defines the component compilers comprising a “parent” partial compiler and at least one child compiler wherein the parent partial compiler receives the sub-plan from the child compiler and incorporates the sub-plan directly into the plan that the parent partial compiler itself returns as output. FIG. 2B may be viewed as illustrating a typical composition operation.

In addition, these implementations may further comprise a set of operators that can be used to manipulate partial compilers as objects. Programs built using these operators together are a form of “structured programming” which manipulates compilers as values. Utilizing a small set of well-defined operations, in turn, can help ensure correctness for the resulting combination of modular compilers (which can be referred to as a “composite compiler”).

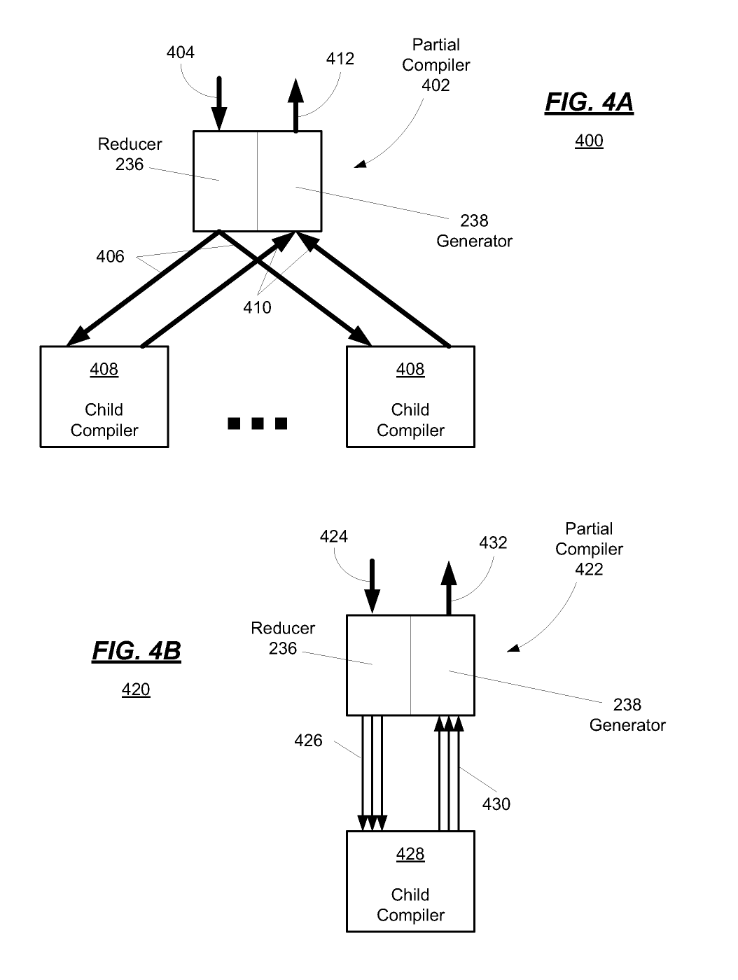

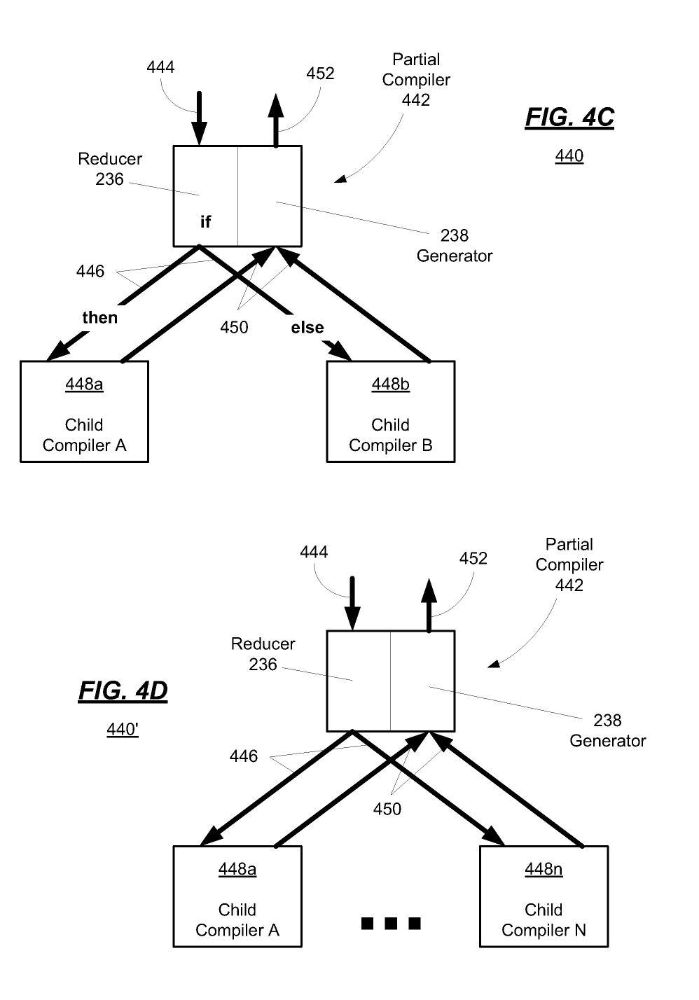

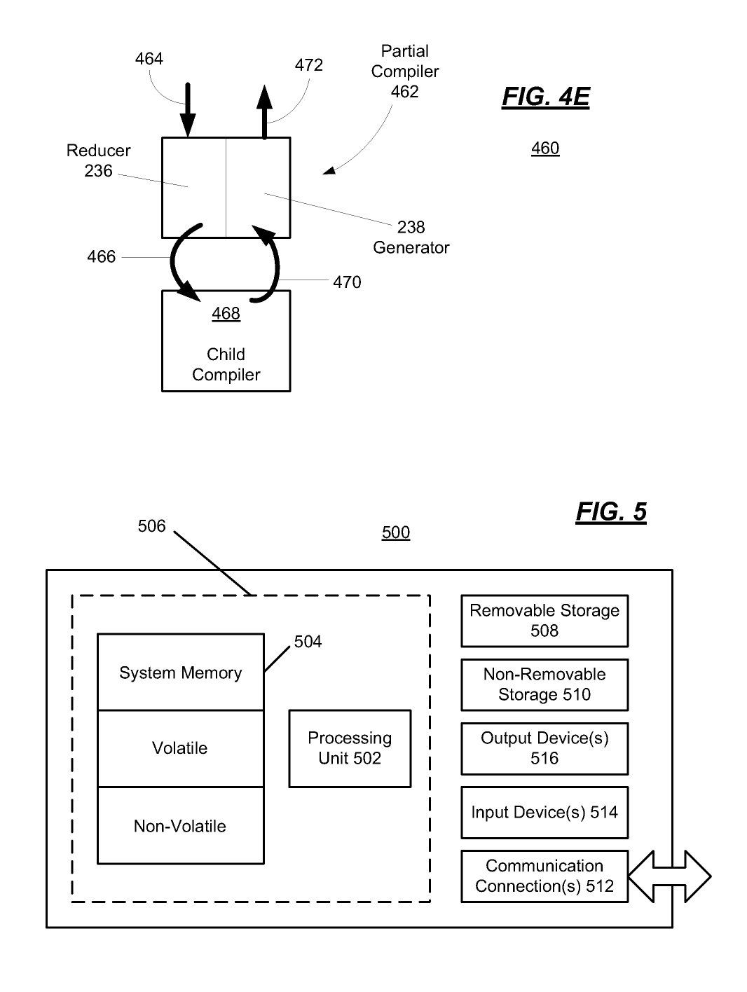

FIG. 4A illustrates an exemplary tensor operation 400 that may be utilized by several implementations disclosed herein. A “tensor” is a pairing operation that invokes multiple child compilers simultaneously. The tensor of n unary partial compilers receives n queries as input and invokes the n partial compilers, each on one of the n queries. As such, it is possible to define a general n-ary composition directly using n unary partial compilers. As illustrated in the figure, a parent partial compiler 402 receives from a calling entity (not shown) a query 404 and, reducing the query into sub-queries, distributes in parallel these sub-queries 406 to a known number of children compilers 408 for parallel processing. The parent partial compiler 402 then receives sub-plans 410 from the children compilers 408 and combines these results to form the plan 412 that is returned to the entity calling the parent partial compiler 402.

FIG. 4B illustrates an exemplary “star” operation 420 that may be utilized by several implementations disclosed herein. Whereas in a tensor operation the number of children compilers is known and distributes sub-queries to the n child compilers for largely identical processing, a “star” operation is one which operates on lists of queries to develop a series of sub-queries for compilation by the same child compiler. In the figure, a parent partial compiler 422 receives from a calling entity (not shown) a query 424 and, reducing the query into sub-queries 426, dynamically distributes in parallel these sub-queries 426 to the child compiler 428 for parallel processing. The parent partial compiler 422 then receives a set of sub-plans 430 from these different instances of the child compilers 428 and further processes these results to form a list of plans 432 that is returned to the entity calling the star partial compiler 422. Using the star operation, a compiler can thus be defined by invoking repeatedly a child compiler to operate on all the sub-queries.

FIG. 4C illustrates an exemplary “conditional” operation 440 that may be utilized by several implementations disclosed herein. While composition, tensor, and star operations are independent from the queries involved—that is, the parent partial compiler reduces and distributes the sub-queries to the child compilers without regard to the content of the query and sub-queries—a conditional operator that operates in accordance with the nature of the query may provide a richer class of compiler composition operations especially when, for example, one child compiler is better suited to process a given query than another. Thus a conditional operation chooses between two child compilers. As such, the conditional operation may be viewed as an “if-then-else” operation (e.g., if(predicate(query))) as illustrated in the figure where a parent partial compiler 442, upon receipt and reduction processing of a query 444, then determines to send the query 444 as a sub-query 446 to either a first child compiler 448a or to a second child compiler 448b, and the selected child compiler 448a or 448b then returns a sub-plan 450 that is then returned as a plan 452 by the parent partial compiler 442 to the calling entity (not shown).

In addition, a “case” operation may also be provided that is an extension of the conditional operation. FIG. 4D illustrates an exemplary “case” operation 440′ that may be utilized by several implementations disclosed herein wherein a larger plurality of child compilers 448a-448n are available for selection; the type of the input query is used to decide which child will handle the query.

In addition, a functor operation can be used to create a partial unary compiler given separate and independent reduction and construction functions operating on queries and plans respectively. Whereas traditional compilers may include a sequence of optimizing passes, for example which transform a query from a higher-level representation to a lower-level representation, a modular compiler may similarly comprise such optimizations constructed using a “functor” operation applied to the optimization functions. Of course, this and others in the group of operations may also be combined together to provided blended functionality.

FIG. 4E illustrates an exemplary “iteration” operation 460 that may be utilized by several implementations disclosed herein. The iteration operation iterates a partial compiler up to n times, stopping if a given predicate becomes true. As such, iteration could be used, for example, to repeatedly apply an optimizing compiler PC until a fixed-point is reached as defined by the predicate. As illustrated, the iteration operation comprises a parent partial compiler 462 receiving a query 464 and then repeatedly sending sub-queries 466 to a child compiler 468, receiving a result plan (a sub-plan 470) and deciding whether to continue using the predicate or to stop. The parent partial compiler 462 then provides a plan 472 to the calling entity (not shown) based on the series of sub-plans 470 serially received from the child compiler 468.

The use of partial compilers in building systems provides decreased design complexity by reducing the number of possible interactions between the components involved. It is also expected that a monolithic compiler applying a sequence of complex optimization passes to an internal representation should be less robust than a collection of partial compilers solving the same problem since the partial compilers communicate through well-defined interfaces and maintain independent representations of their sub-problems. Moreover, the correctness of compilers and partial compilers can be treated modularly as correctness is preserved by all operations, and correct compilers can even be assembled from partial compilers or compilers that are only correct for some queries. Restricted correctness can also be treated modularly, and a natural Hoare-type logic can be defined to reason about correctness in this circumstance. For example, a conditional partial compiler may be used to fix bugs in a child compiler by sending queries which the child cannot handle correctly to an alternative child. Alternately, a conditional partial compiler can be used to route a query either to a GPU-compiler or to a multi-core compiler, depending on whether the query can be compiled for a GPU or not.

FIG. 5 shows an exemplary computing environment in which example implementations and aspects may be implemented. The computing system environment is only one example of a suitable computing environment and is not intended to suggest any limitation as to the scope of use or functionality. Numerous other general purpose or special purpose computing system environments or configurations may be used. Examples of well known computing systems, environments, and/or configurations that may be suitable for use include, but are not limited to, personal computers (PCs), server computers, handheld or laptop devices, multiprocessor systems, microprocessor-based systems, network personal computers, minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 5, an exemplary system for implementing aspects described herein includes a computing device, such as computing device 500. In its most basic configuration, computing device 500 typically includes at least one processing unit 502 and memory 504. Depending on the exact configuration and type of computing device, memory 504 may be volatile (such as random access memory (RAM)), non-volatile (such as read-only memory (ROM), flash memory, etc.), or some combination of the two. This most basic configuration is illustrated in FIG. 5 by dashed line 506.

Computing device 500 may have additional features/functionality. For example, computing device 500 may include additional storage (removable and/or non-removable) including, but not limited to, magnetic or optical disks or tape. Such additional storage is illustrated in FIG. 5 by removable storage 508 and non-removable storage 510.

Computing device 500 typically includes a variety of computer readable media. Computer readable media can be any available media that can be accessed by device 500 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 504, removable storage 508, and non-removable storage 510 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 500. Any such computer storage media may be part of computing device 500.

Computing device 500 may contain communication connection(s) 512 that allow the device to communicate with other devices. Computing device 500 may also have input device(s) 514 such as a keyboard, mouse, pen, voice input device, touch input device, etc. Output device(s) 516 such as a display, speakers, printer, etc. may also be included. All these devices are well known in the art and need not be discussed at length here.

It should be understood that the various techniques described herein may be implemented in connection with hardware or software or, where appropriate, with a combination of both. Thus, the methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A modular compiler comprising:
a first partial compiler utilizing a first child compiler; and
a first self-contained compiler operatively coupled to the first partial compiler as the first child compiler for the first partial compiler.

2. The modular compiler of claim 1, further comprising a second partial compiler utilizing a second child compiler, and to which the first partial compiler is operatively coupled as the second child compiler for the second partial compiler.

3. The modular compiler of claim 2, wherein the first partial compiler and the second partial compiler each comprise a reducer and a generator.

4. The modular compiler of claim 3, wherein the reducer is separate from the generator.

5. The modular compiler of claim 1, wherein either the first partial compiler or the second partial compiler is constructed using an operation from among the following group of operations: composition operation, tensor operation, star operation, conditional operation, case operation, functor operation, and iteration operation.

6. The modular compiler of claim 1, wherein the first partial compiler targets a first processor core and the first child compiler targets a second processor core.

7. The modular compiler of claim 1, wherein the child compiler is a self-contained compiler.

8. The modular compiler of claim 1, wherein a compilation utilizing at least one partial compiler is for execution on a cluster.

9. A partial compiler comprising:
a reducer for receiving a query as input, reducing the query into at least one sub-query, and sending a sub-query to a child compiler; and
a generator for accepting a sub-plan from a child compiler, generating a plan based at least in part on the sub-plan received from the child compiler, in a manner dependent on the compiled query, and returning the plan as output.

10. The partial compiler of claim 9, wherein the sub-plan accepted from the child compiler is in response to the sub-query sent to the child compiler.

11. The partial compiler of claim 9, wherein the reducer and the generator are separate, and wherein the generator is dependent on the compiled query.

12. The partial compiler of claim 9, wherein the partial compiler compiles at least part of the plan separate from the accepted sub-plan.

13. The partial compiler of claim 9, wherein the child compiler is one of a partial compiler or a self-contained compiler.

14. The partial compiler of claim 9, wherein the child compiler executes without exposing its internal operation to the partial compiler.

15. The partial compiler of claim 9, wherein the reducer receives the query from a calling entity, and wherein partial compiler executes without exposing its internal operation to the calling entity.

16. A computer-readable medium comprising computer-readable instructions for a partial compiler, the computer-readable instructions comprising instructions that cause a processor to:
reduce a query into a sub-query;
send the sub-query to a child compiler;
accept a sub-plan from the child compiler; and
generate a plan utilizing the sub-plan.

17. The computer-readable medium of claim 16, wherein the sub-plan accepted from the child compiler is in response to the sub-query sent to the child compiler.

18. The computer-readable medium of claim 16, further comprising instructions for causing the processor to perform at least one operation from among the following group of operations:
composition operation, tensor operation, star operation, conditional operation, case operation, functor operation, and iteration operation.

19. The computer-readable medium of claim 16, further comprising instructions for partially compiling the query for the plan separate from the sub-plan.

20. The computer-readable medium of claim 19, further comprising instructions that cause the partial compiler to analyze the query and elect to operate as either a self-contained compiler or as a partial compiler.
